(19) United States
(12) Patent Application Publication
(10) Pub. No.: US 2009/0094658 A1
(43) Pub. Date: Apr. 9, 2009

(54) METHODS AND SYSTEMS FOR DRIVING MULTIPLE DISPLAYS

(75) Inventor: Osamu KOBAYASHI, Los Altos, CA (US)

Correspondence Address: Beyer Law Group LLP, P.O. BOX 1687, Cupertino, CA, 95015-1687, US

(73) Assignee: Genesis Microchip Inc., Santa Clara, CA (US)

(21) Appl. No.: 12/248,822

(22) Filed: Oct. 9, 2008

Related U.S. Application Data
(60) Provisional application No. 60/978,694, filed on Oct. 9, 2007.

(51) Int. Cl. H04N 7/173

(52) U.S. Cl. 725/118

(57) ABSTRACT

Methods and systems are described for providing multimedia streams to a plurality of display devices coupled with a source device. An example method includes mapping a first subset of pixels for display on a first one of the plurality of display devices from a native stream at a source device to a first stream, mapping a second subset of pixels for display on a second one of the plurality of display devices from the native stream to a second stream, and transmitting simultaneously the first and second streams from the source device.

### CROSS-REFERENCE TO RELATED APPLICATION

This patent application claims the benefit of priority under 35 U.S.C. 119(e) to U.S. Provisional Patent Application Ser. No. 60/978,694 (Attorney Docket No. GENSP202P) filed Oct. 9, 2007 and entitled “DRIVING A MULTI-DISPLAY SINK DEVICE,” which is hereby incorporated by reference herein for all purposes.

This patent application is also related to U.S. patent application Ser. No. 10/726,794 (Attorney Docket No. GENSP013) filed Dec. 2, 2003 and entitled “PACKET BASED VIDEO DISPLAY INTERFACE AND METHODS OF USE THEREOF,” and U.S. patent application Ser. No. 10/762,680 (Attorney Docket No. GENSP047) filed Jan. 21, 2004 and entitled “PACKET BASED HIGH DEFINITION HIGH-BANDWIDTH DIGITAL CONTENT PROTECTION,” both of which are hereby incorporated by reference herein for all purposes.

### TECHNICAL FIELD

The present invention relates generally to display interfaces. More particularly, methods and systems are described for driving multiple displays with a single source device.

### BACKGROUND OF THE INVENTION

Currently, video display technology is divided into analog type display devices (such as cathode ray tubes) and digital type display devices (such as liquid crystal display, plasma screens, etc.), each of which must be driven by specific input signals in order to successfully display an image. A typical system includes a source device (such as a personal computer, DVD player, etc.) coupled directly to a display (sink) device by way of a communication link. The communication link typically takes the form of a cable that plugs into corresponding interfaces on each of the coupled devices. The exploding growth of digital systems has made the use of digital cables more desirable.

While existing systems, interfaces and cables work well for many applications, there is an increasing demand for more integrated systems that facilitate ease of use and/or more functionality. In particular, it would be desirable to have the capability to drive multiple displays with a single video source device.

### SUMMARY OF THE INVENTION

In one aspect, a method for providing multimedia streams to a plurality of display devices coupled with a source device is described. The method includes mapping a first subset of pixels for display on a first one of the plurality of display devices from a native stream at a source device to a first stream, mapping a second subset of pixels for display on a second one of the plurality of display devices from the native stream to a second stream, and transmitting simultaneously the first and second streams from the source device.

In various embodiments, a first link couples the first one of the plurality of display devices to the source device and a second link couples the first one of the plurality of display devices to the second one of the plurality of display devices. In one embodiment, the first and second streams are transmitted simultaneously over the first link to the first one of the plurality of display devices. In a particular embodiment, each of the transmitted streams has identical video timing and pixel bit depth. In such an embodiment, the first stream can be sent over a first lane of the first link while the second stream is sent over a second different lane of the first link. The method may further include transmitting the second stream from the first one of the plurality of display devices to the second one of the plurality of display devices over the second link. Additionally, in a particular embodiment, the plurality of display devices are arranged in a daisy chain configuration and only the most upstream display device of the plurality of display devices is directly coupled with the source device.

In another aspect of the invention, a chip of a source device configured to provide multimedia streams to a plurality of display devices at certain times when the plurality of display devices are coupled with the source device, is described. The chip may include code configured to perform steps including the following when executed by the chip: mapping a first subset of pixels for display on a first one of the plurality of display devices from a native stream at the source device to a first stream; mapping a second subset of pixels for display on a second one of the plurality of display devices from the native stream to a second stream; and transmitting simultaneously the first and second streams from the source device. The code may also be configured to be compatible with a system configuration that includes: a first link coupling the first one of the plurality of display devices to the source device; and a second link coupling the first one of the plurality of display devices to the second one of the plurality of display devices; such that the first and second streams are transmitted simultaneously over the first link to the first one of the plurality of display devices. The chip may include a processor coupled to a memory device, where at least part of the code is stored in the memory device. Also, or in alternative, at least part of the code may include firmware embedded in circuitry of the chip.

In another aspect of the invention, a system is described that is arranged and configured to perform a method such as that just described.

In still another aspect of the invention, computer program product including computer code is described that, when executed, is able to perform a method such as that just described.

### BRIEF DESCRIPTION OF THE DRAWINGS

The invention and the advantages thereof may best be understood by reference to the following description taken in conjunction with the accompanying drawings in which:

FIG. 1 illustrates a multi-display system in accordance with an embodiment of the present invention.

FIG. 2 illustrates a link suitable for use in the system of FIG. 1.

FIG. 3 is a flowchart illustrating a process for transporting multiple multimedia streams in accordance with an embodiment of the present invention.

FIG. 4 illustrates a source device coupled with a sink device via a link in accordance with an embodiment of the present invention.

FIG. 5 illustrates a table showing packet parameters for video timing in accordance with an embodiment of the present invention.

FIG. 6 illustrates a source device coupled with a sink device via a link in accordance with an embodiment of the present invention.

FIG. 7 illustrates a source device coupled with a sink device via a link in accordance with an embodiment of the present invention.

FIG. 8 illustrates a source device coupled with a sink device via a link in accordance with an embodiment of the present invention.

FIG. 9 illustrates a table showing video timing parameters in accordance with an embodiment of the present invention

FIG. 10 is a flowchart illustrating a process for communicating display configurations and for routing multimedia streams to associated displays.

FIG. 11 illustrates a multi-display system in accordance with an embodiment of the present invention.

In the drawings, like reference numerals are sometimes used to designate like structural elements. It should also be appreciated that the depictions in the figures are diagrammatic and not to scale.

### DETAILED DESCRIPTION OF EXAMPLE EMBODIMENTS

The present invention relates generally to display interfaces. More particularly, methods and systems are described for driving multiple displays with a single source device.

In the following description, numerous specific details are set forth to provide a thorough understanding of the present invention. It will be apparent, however, to one skilled in the art that the present invention may be practiced without some or all of these specific details. In other instances, well known process steps have not been described in detail in order to avoid unnecessary obscuring of the present invention.

The following description focuses on embodiments involving a single video source coupled with multiple display (sink) devices. The video source may be any suitable video, audio and/or data source device including a desktop computer, portable computer, DVD player, Blu-ray player, set-top box or video graphics card, among others. Generally, the display devices may be digital displays such as, by way of example, computer display monitors, LCD televisions, plasma televisions, and other display monitors. In various embodiments, the video source and display devices include some sort of digital copy protection such as that described in, by way of example, U.S. patent application Ser. No. 10/762,680 (Attorney Docket No. GENSP047), which is incorporated by reference herein. Additionally, the described embodiments are particularly well-suited for use with high-definition (HD) content.

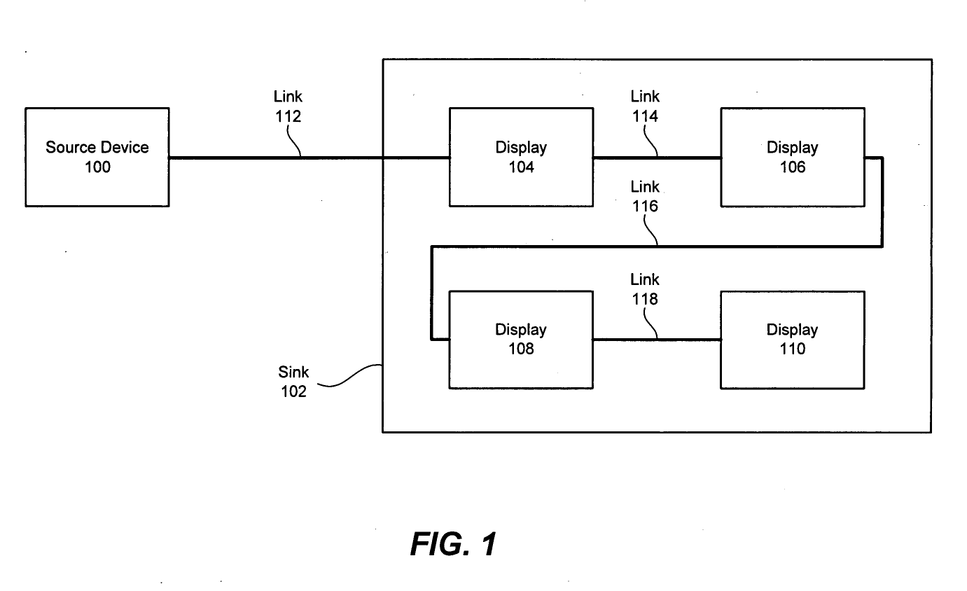

FIG. 1 illustrates a particular embodiment in which a single source device 100 is coupled with a multi-display sink 102 (hereinafter referred to as multi-display 102) via a link 112. In the illustrated embodiment, the multi-display 102 includes four displays 104, 106, 108 and 110. However, it is noted that the number of displays is generally usage dependent and that greater or fewer than four displays may be utilized in various other embodiments. In one embodiment, the multiple displays 104, 106, 108 and 110 are all physically enclosed in a single chassis. In an alternate embodiment, each (or a subset) of the displays 104, 106, 108 and 110 may be physically enclosed in its own chassis (that is, each of the displays 104, 106, 108 and 110 may be associated with its own individual television or other form of stand-alone display device). However, for ease of description, the combined group of displays 104, 106, 108 and 110 will generally be referred to herein as a single multi-display 102.

In the embodiment illustrated in FIG. 1, the displays 104, 106, 108 and 110 are coupled with one another via a cascaded daisy-chain arrangement. More specifically, link 112 connects source device 100 directly with display 104, a second link 114 connects display 104 directly with display 106, a third link 116 connects display 106 directly with display 108, and a fourth link 118 connects display 108 directly with display 110. In the illustrated embodiment, no other data links interconnect any one of the displays 104, 106, 108 and 110 with any of the others or to the source device 100 except for the links 112, 114, 116 and 118. However, in alternate embodiments, it may be desirable to interconnect ones of the displays 104, 106, 108 and/or 110 with other ones of the displays or the source device 100 via links other than one of links 112, 114, 116 and 118.

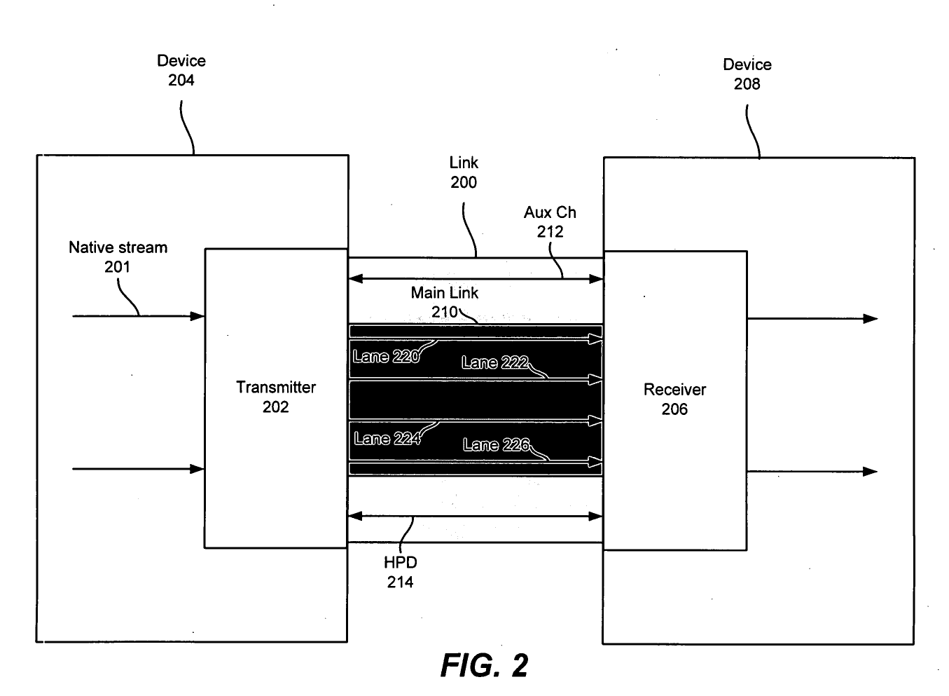

In a particular preferred embodiment, each of the links 112, 114, 116 and 118 is configured for packet-based digital transport such as that described in, by way of example, U.S. patent application Ser. No. 10/726,794 (Attorney Docket No. GENSP013) which is incorporated by reference herein. FIG. 2 illustrates a diagram of a general link 200 that can be used in various embodiments of the present invention. By way of example, link 200 may be suitable for use as any one of links 112, 114, 116 and/or 118. In the illustrated embodiment, link 200 connects a transmitter interface 202 at a first compliant device 204 with a receiver interface 206 at a second compliant device 208.

Such a link 200 may include a uni-directional main link 210 for transporting isochronous streams downstream (e.g., from a source device to a display device). By way of example, the streams may comprise audio and video packets. In one example embodiment, the main link 210 can generally be configured to support 1, 2 or 4 data pairs, also referred to herein as lanes. In the illustrated embodiment, main link 210 supports four lanes 220, 222, 224 and 226. In a preferred embodiment, the link rate of the main link 210 and of the individual lanes 220, 222, 224 and 226 is decoupled from the pixel rate of the native video stream(s) 201 received by the transmitter interface 202. The pixel rate may be regenerated from the link symbol clock using time stamp values. Additionally, the number of lanes may be decoupled from the pixel bit depth (bits per pixel (bpp)). Generally, source and display devices are allowed to support the minimum number of lanes required for their needs. By way of example, devices that support two lanes can be required to support both one and two lanes. Similarly, devices that support four lanes can be required to support 1, 2 and 4 lanes.

In addition to main link 210, link 200 also includes a bi-directional auxiliary channel 212. Auxiliary channel 212 may be configured for half-duplex communication between coupled devices 204 and 208 connected with link 200. In an example embodiment, auxiliary channel 212 is utilized for link management and device control. Link 200 may also include a hot plug detect (HPD) signal line 214 for detecting when an active display device is coupled with the source device thus facilitating robust plug-n-play ease of use. The HPD signal can serve as an interrupt request by a display device. Generally, a source device (e.g., video source device 100) serves as the master device while a display device (e.g., displays 104, 106, 108 and 110) serves as the slave. As such, transactions over the auxiliary channel 212 are generally initiated by the source device. However, a display device may prompt the initiation of a transaction over the auxiliary channel 212 by sending an interrupt request (IRQ) to the source device by toggling the HPD signal 214.

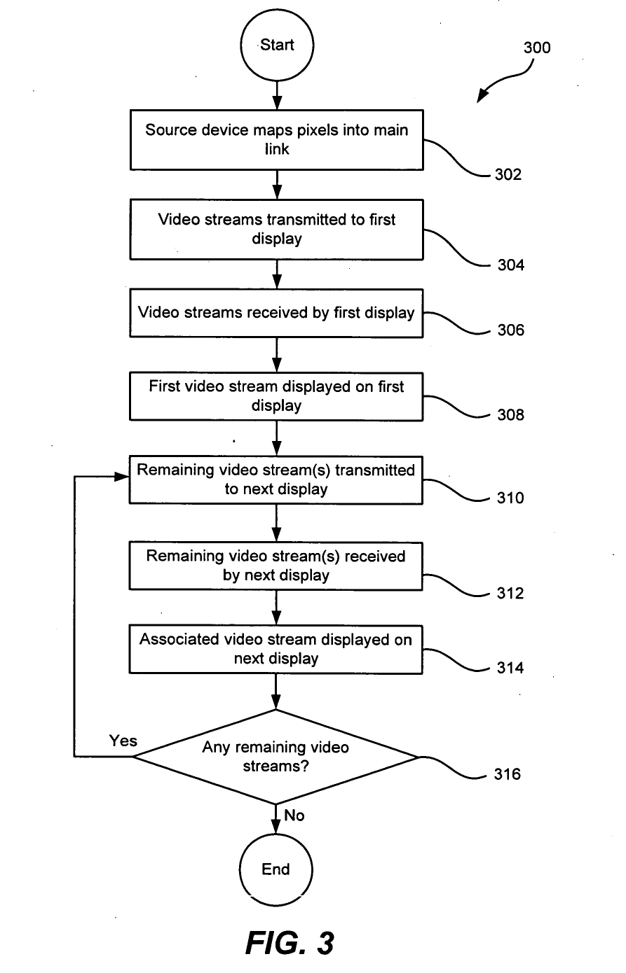

With reference to FIG. 1 and the flowchart of FIG. 3, an example process 300 for transporting multiple multimedia (e.g., video) streams will be described. In the illustrated embodiment, source device 100 transmits four multimedia streams 120, 122, 124 and 126 over link 112; however, the number of streams may vary in alternate embodiments. In a particular embodiment, each of the streams 120, 122, 124 and 126 has identical video timing and pixel bit depth to the other streams. Video stream 120 is intended to be displayed on display 104, while video stream 122 is intended for display 106, video stream 124 is intended for display 108, and video stream 126 is intended for display 110.

The process begins at 302 with the source device 100 mapping pixels into the main link of link 112. In a particular embodiment, the mapping of the pixels by the source device occurs at a link layer level. The link layer can provide for isochronous transport services as well as link and device services. Isochronous transport services in the source device map the video and audio streams into the main link with a set of rules such that the streams can be properly reconstructed into the original format and time base by the associated display device.

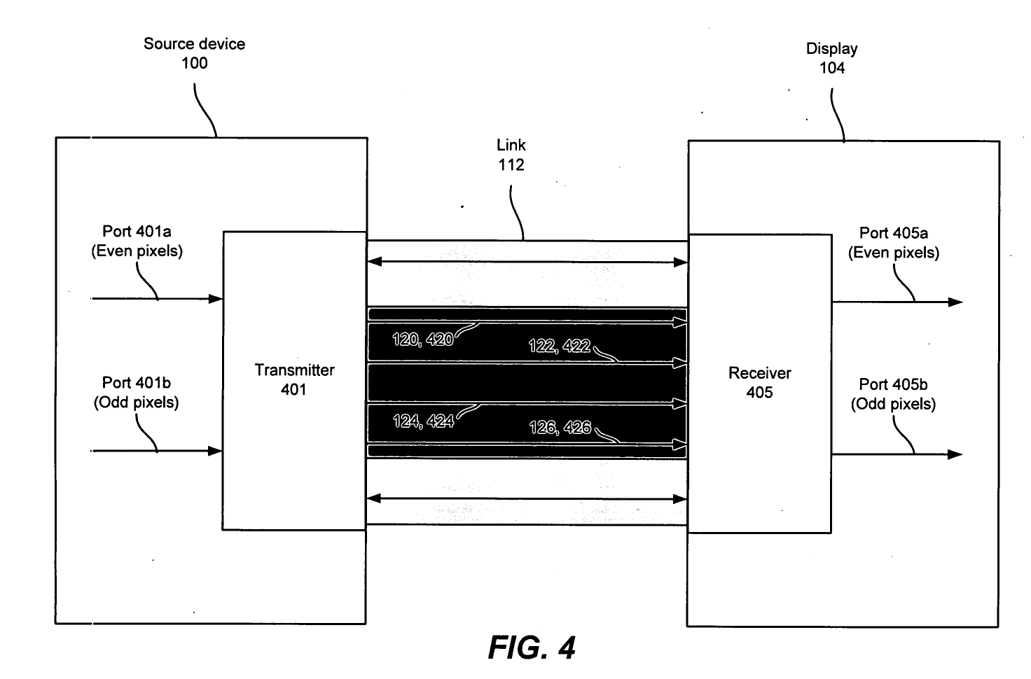

FIG. 4 illustrates source device 100 and display device 104 coupled with link 112. In the illustrated embodiment, pixels associated with video stream 120, for example pixels 0, 4, 8, 12 . . . , are mapped into lane 420 of link 112. Similarly, pixels 1, 5, 9, 13 . . . , associated with video stream 122, are mapped into lane 422; while pixels 2, 6, 10, 14 . . . , associated with video stream 124, are mapped into lane 424; and pixels 3, 7, 11, 15 . . . , associated with video stream 126, are mapped into lane 426. In the described embodiment, even pixels (pixels 0, 2, 4, . . . 2558) are mapped to lanes 420 and 424 while odd pixels (pixels 1, 3, 5, . . . 2559) are mapped to lanes 422 and 426. It should be appreciated that the specific pixels, and more generally the pixel mapping algorithm, mapped into each lane may vary widely in alternate embodiments.

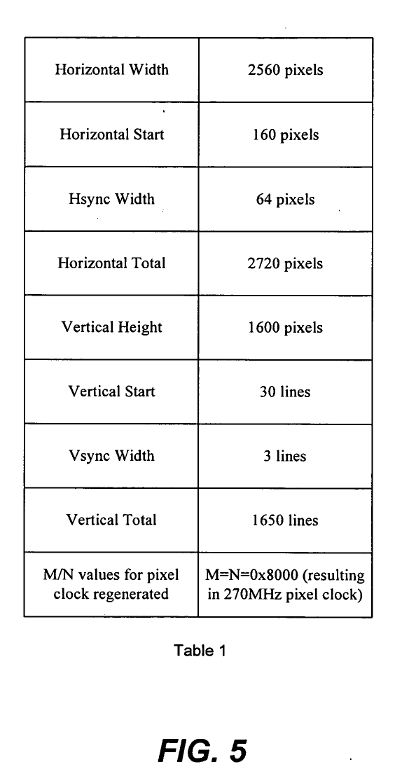

The pixels are transmitted in their respective lanes over the main link 112 to the first display 104 at step 304. The attributes of the transported video streams can be conveyed in Main Stream Attribute (MSA) packets. In the described embodiment, a MSA packet is sent once per video frame during the vertical blanking period. By way of example, when a 2560×1600@60 Hz (pixel clock=270 MHz) video stream is transported, the MSA packet parameters for video timing may be as follows from Table 1 shown in FIG. 5.

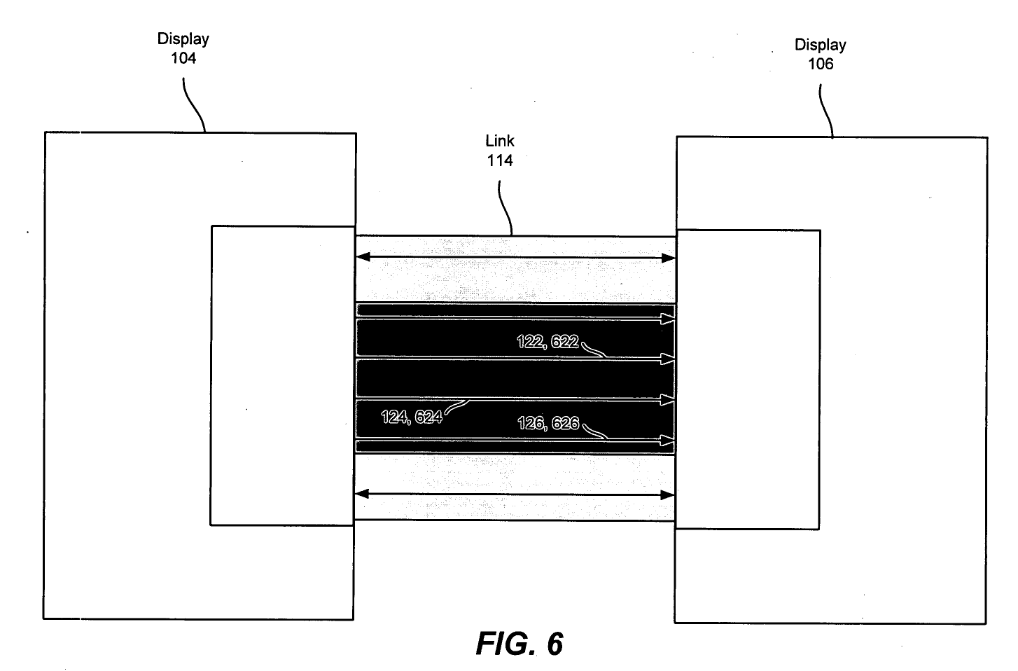

At 306, the video streams 120, 122, 124 and 126 are received by the first display 104. The associated video stream 120 is displayed on the first display 104 at 308. The display 104 then transmits the remaining video streams at 310 to the next display. By way of example, in the illustrated embodiment, display 104 transmits streams 122, 124 and 126 over lanes 622, 624 and 626 of link 114, respectively, to the second display 106, as shown in FIG. 6. The streams 122, 124 and 126 are received by display 106 at 312. Subsequently, display 106 then displays associated video stream 122 at 314.

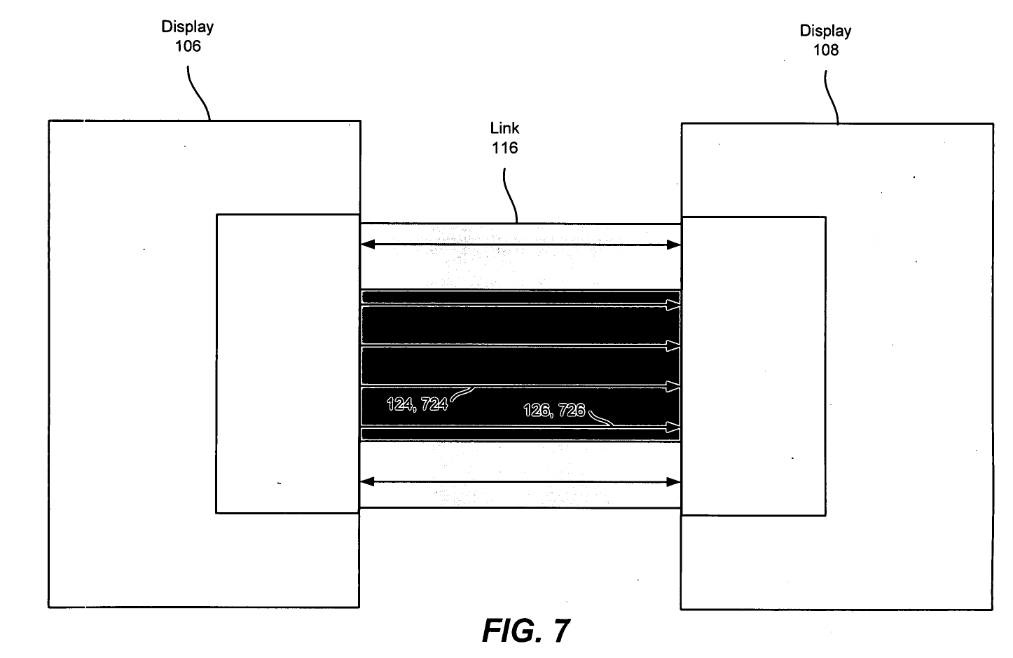

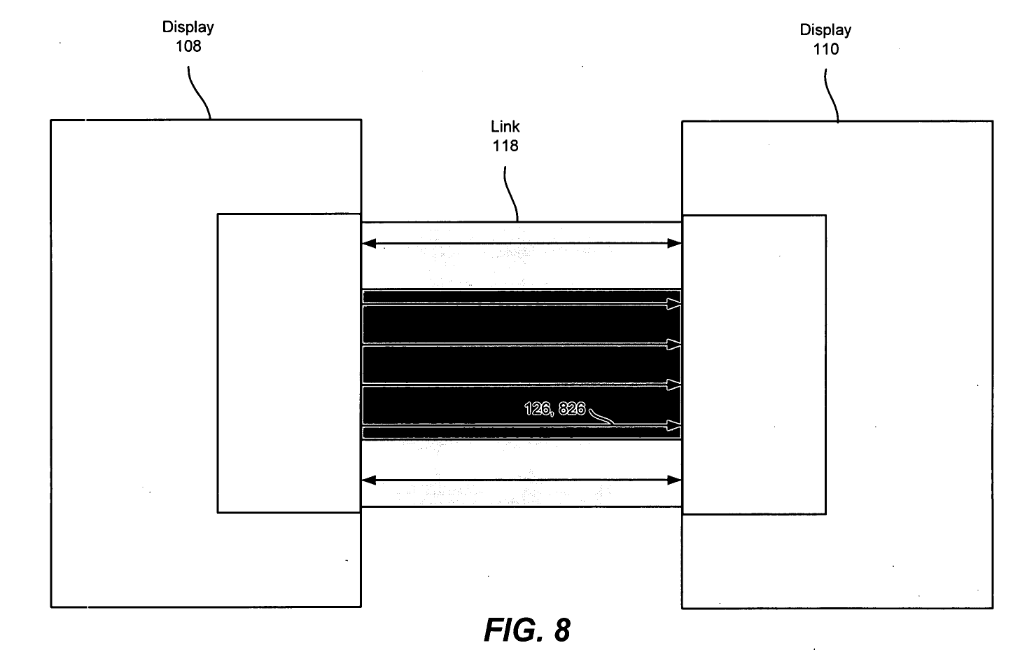

Next, it is then determined at 316 whether or not there are any remaining streams. If there are no remaining streams to transmit, the process ends. If, however, there are remaining streams, as in the illustrated embodiment, the process returns to step 310. By way of example, display 106 would then transmit the remaining streams 124 and 126 via lanes 724 and 726 to the third display 108 as in FIG. 7. The third display 108 then receives streams 124 and 126 and subsequently displays stream 124. Similarly, display 108 then transmits stream 126 to the fourth display 110 via lane 826 as shown in FIG. 8, where it is then displayed.

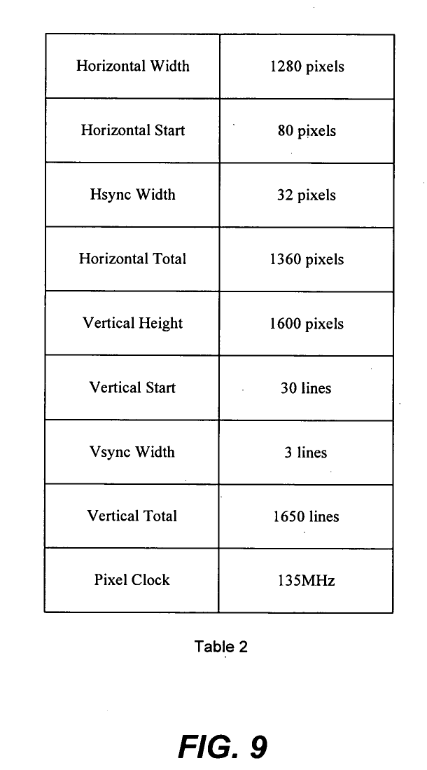

In one specific example embodiment a receiver 405 at display 104 is configured to output the combined 2560×1600 video streams via two output ports 405a and 405b, one for even pixels and the other for odd pixels, respectively, thus constituting a 2-pixels-per-clock output. Similarly, a transmitter 401 at source device 100 can be arranged to include two input ports 401a and 401b configured to receive a corresponding even pixel video stream and a corresponding odd pixel video stream, respectively. In such an example embodiment, each output port (405a and 405b) of the receiver 405 outputs 1280 pixels by 1600 lines of pixel data per video frame with 135 MHz pixel clock. In one embodiment, the timing parameters of each of the 2-pixels-per-clock output ports may be as follows in Table 2 shown in FIG. 9.

Such a pixel mapping framework may be used to transport two streams of identical video timing and pixel bit depth over the main link. In an example multi-stream operation, the transmitter 401 of the source device 100 programs the horizontal parameters, which are twice that of the regenerated streams, into the MSA packet. In other words, when the source device 100 is transporting two 1280×1600 streams each with the video timing given in Table 2, the transmitter 401 will send the MSA packet as provided by Table 1.

In an example embodiment, the receiver 405 will then divide the horizontal video timing parameters and the pixel clock by two and output two 1280×1600 streams. Such a multi-stream mapping feature can be extended beyond two streams. By way of example, when four streams are transported simultaneously, lanes 420, 422, 424 and 426 will carry streams 120, 122, 124 and 126, respectively. The horizontal timing parameters within the MSA packet will then be quadruple of those of each individual stream. The three-stream transport scenario may be treated similarly to the four-stream method described above, while data symbols transported over, for example, the third lane (e.g., lane 424) will be ignored.

As should be appreciated, the number of streams can be more than four as well. Furthermore, the multi-stream transport of identical video timing and pixel bit depth can be achieved over one and two-lane main link configurations.

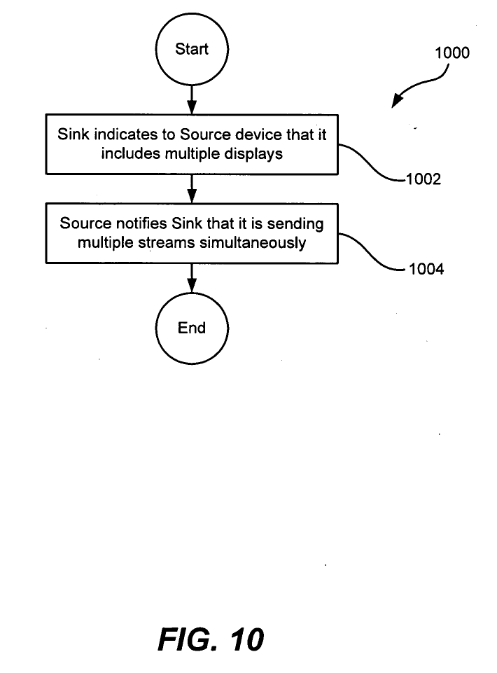

In order for a display device, such as multi-display 102, consisting of multiple daisy-chained displays, by way of example the four displays 104, 106, 108 and 110, to properly receive and route multiple streams of identical video timing and pixel bit depth, a series of handshakes facilitate the transaction between the source device 100 and the multi-display 102. With reference to the flowchart of FIG. 10, an example process 1000 is described for properly communicating the display configurations and for routing the video streams to the associated displays. At step 1002, the multi-display 102 indicates to the source device 100 that it consists of multiple displays (e.g., the four displays 104, 106, 108, 110). The source device 100 then notifies the multi-display 102 (which may involve notifying each of the displays) at 1004 that it is sending a number of streams simultaneously.

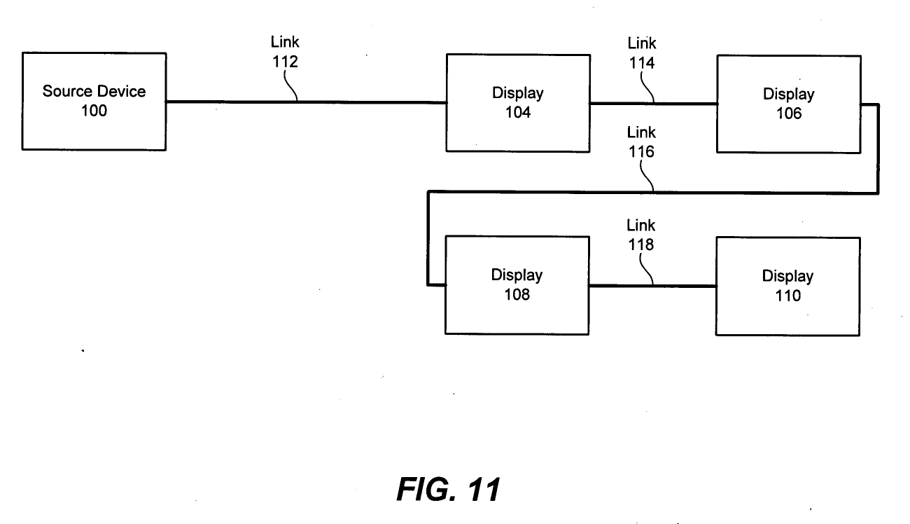

FIG. 11 illustrates an embodiment in which multi-display 102 actually includes four displays 104, 106, 108 and 110 each enclosed in its own separate chassis with its own configuration data and extended display information data (EDID). The configuration data in an associated display device describes the capability of the receiver, while the EDID describes that of the associated display device. In addition, configuration data can store the associated link status information, for example, whether the link is synchronized or not, for link maintenance purposes.

In an example embodiment, during step 1002, each display in the multi-display 102 will indicate the maximum number of streams (e.g., with identical video timing and pixel bit depth) it can simultaneously receive by using a sink-specific field of the configuration data. In such an example embodiment, the maximum number of streams may be stored in four bits. The value stored in those four bits will be the maximum stream count minus 1.

Generally, the number of displays cascaded in a daisy-chained manner will be usage dependent. By way of example, even if a display may be able to receive up to four streams, only two of such displays may be cascaded to constitute a multi-display sink. The displays constituting the associated multi-display will generally need to determine how many displays are daisy-chained in the multi-display and where each display is located in the daisy chain. The display count and location identification can be achieved by using the configuration data, which indicate the number of displays within the multi-display and connected with its downstream port.

In an example embodiment in which the multi-display 102 consists of four displays (as described above with reference to FIG. 1), the most downstream display in the multi-display (e.g., display 110) will have the value of 1 in an associated configuration data address. In this embodiment, the second from the most downstream device (e.g., display 108) may have the value of 2 at this address, while the third from the most downstream device (e.g., display 106) has the value of 3 and the fourth most downstream device (in this case the most upstream display 104) has the value of 4.

The EDID can indicate the display capabilities of each associated display. In the described embodiment, in which the multi-display 102 consists of four displays 104, 106, 108 and 110, each displaying 1280×1024 resolution, the EDID indicates 1280×1024 resolution. In an alternate embodiment, in which the associated resolutions of the displays 104, 106, 108 and 110 vary, the upstream display (e.g., display 104) will indicate the largest resolution that is supported by all of the displays downstream (e.g., displays 106, 108 and 110).

In a particular embodiment, the source device 100, upon detecting the multi-display 102, may choose to send the number of streams up to equal to the maximum streams the display can receive simultaneously. In such an embodiment, the MISCI byte of the MSA packet may be used for this purpose. The value set in the associated bits will be the number of streams minus 1.

In the described embodiment, the most upstream device (e.g., device 104) will sink stream 120, which is transmitted on lane 420 for 4-stream-over-4-lane operation, and forward the remaining streams (e.g., 122, 124 and 126) to their respective intended displays (e.g., 106, 108 and 110). The next downstream display in the daisy chain (e.g., display 106) will similarly sink stream 122 and forward the remaining streams (e.g., 124 and 126) to the remaining displays (e.g., 108 and 110). This sinking and forwarding will continue until the final most downstream display (e.g., 110) is reached.

In addition, embodiments of the present invention further relate to integrated circuits and chips (including system on a chip (SOC)) and/or chip sets as well as firmware for performing the processes just described. By way of example, each of the source and displays devices may include a chip or SOC for use in implementing the described embodiments and similar embodiments. Embodiments may also relate to computer storage products with a computer-readable medium that has computer code thereon for performing various computer-implemented operations. The media and computer code may be those specially designed and constructed for the purposes of the present invention, or they may be of the kind well known and available to those having skill in the computer software arts. Examples of tangible computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method for providing multimedia streams to a plurality of display devices coupled with a source device, comprising:
mapping a first subset of pixels for display on a first one of the plurality of display devices from a native stream at a source device to a first stream;
mapping a second subset of pixels for display on a second one of the plurality of display devices from the native stream to a second stream; and
transmitting simultaneously the first and second streams from the source device.

2. The method as recited in claim 1, wherein a first link couples the first one of the plurality of display devices to the source device, wherein a second link couples the first one of the plurality of display devices to the second one of the plurality of display devices, and wherein the first and second streams are transmitted simultaneously over the first link to the first one of the plurality of display devices.

3. The method as recited in claim 2, further comprising transmitting the second stream from the first one of the plurality of display devices to the second one of the plurality of display devices over the second link.

4. The method as recited in claim 2, wherein the first stream is sent over a first lane of the first link and wherein the second stream is sent over a second different lane of the first link.

5. The method as recited in claim 2, wherein each of the first and second links includes a unidirectional main link arranged to transport packets downstream and a bi-directional auxiliary channel arranged to transfer information between the two associated coupled devices.

6. The method as recited in claim 1, wherein the plurality of display devices are arranged in a daisy chain configuration and wherein only the most upstream display device of the plurality of display devices is directly coupled with the source device.

7. The method as recited in claim 2, wherein the plurality of display devices are arranged in a daisy chain configuration and wherein only the most upstream display device of the plurality of display devices is directly coupled with the source device,
wherein the plurality of display devices includes four daisy-chained devices, the second one of the plurality of display devices being coupled with a third one of the plurality of display devices via a third link, the third of the plurality of display devices being coupled with a fourth one of the plurality of display devices via a fourth link, the method further comprising
mapping a third subset of pixels for display on the third one of the plurality of display devices to a third stream;
mapping a fourth subset of pixels for display on the fourth one of the plurality of display devices to a fourth stream;
transmitting simultaneously the third and fourth streams from the source device to the first one of the plurality of display devices over the first link simultaneously with the transmitting of the first and second streams; and
transmitting simultaneously the second, third and fourth streams from the first one of the plurality of display devices to the second one of the plurality of display devices over the second link.

8. The method as recited in claim 7, further comprising
transmitting the third and fourth streams from the second one of the plurality of display devices to the third one of the plurality of display devices over the third link; and
transmitting the fourth stream from the third one of the plurality of display devices to the fourth one of the plurality of display devices over the fourth link.

9. The method as recited in claim 1, wherein the at least two display devices form a multi-display sink, the method further comprising indicating to the source device by the multi-display sink that the multi-display sink comprises multiple displays.

10. The method as recited in claim 9, further comprising determining how many displays are in the multi-display sink.

11. The method as recited in claim 9, further comprising determining where each display of the multi-display sink is located in the daisy-chain.

12. The method as recited in claim 9, further comprising notifying the multi-display sink by the source device that the source device is sending a plurality of streams simultaneously.

13. The method as recited in claim 9, wherein each one of the plurality of display devices indicates to the source device the maximum number of streams it can simultaneously receive.

14. The method as recited in claim 1, wherein each of the transmitted streams has identical video timing and pixel bit depth.

15. A system for providing multimedia streams, comprising:
a plurality of display devices;
a source device configured to map a first subset of pixels for display on a first one of the plurality of display devices from a native stream to a first stream, and to map a second subset of pixels for display on a second one of the plurality of display devices from the native stream to a second stream, the source device being further configured to transmit simultaneously the first and second streams from the source device.

16. The system as recited in claim 15, further comprising:
a first link that couples the first one of the plurality of display devices to the source device; and
a second link that couples the first one of the plurality of display devices to the second one of the plurality of display devices,
wherein the source device is configured to transmit both the first and second streams simultaneously over the first link to the first one of the plurality of display devices.

17. The system as recited in claim 16, wherein the first one of the plurality of display devices is configured to transmit the second stream over the second link to the second one of the plurality of display devices.

18. The system as recited in claim 16, wherein the first stream is sent over a first lane of the first link and wherein the second stream is sent over a second different lane of the first link.

19. The system as recited in claim 16, wherein the plurality of display devices are arranged in a daisy chain configuration and wherein only the most upstream display device of the plurality of display devices is directly coupled with the source device.

20. The system as recited in claim 15, wherein each of the transmitted streams has identical video timing and pixel bit depth.

21. The system as recited in claim 15, wherein all of the daisy-chained display devices are enclosed in a single chassis.

22. The system as recited in claim 15, wherein each of the daisy-chained display devices is enclosed in its own individual chassis.

23. Computer program product encoded in one or more tangible media for execution by a processor of a source device, the computer program product being adapted to provide multimedia streams to a plurality of display devices at various times when coupled with the source device, when executed the computer program product comprising code operable to:
map a first subset of pixels for display on a first one of the plurality of display devices from a native stream at the source device to a first stream;
map a second subset of pixels for display on a second one of the plurality of display devices from the native stream to a second stream; and
transmit simultaneously the first and second streams from the source device.

24. A chip of a source device configured to provide multimedia streams to a plurality of display devices at various times when the plurality of display devices are coupled with the source device, the chip comprising circuitry configured to:
map a first subset of pixels for display on a first one of the plurality of display devices from a native stream at the source device to a first stream;
map a second subset of pixels for display on a second one of the plurality of display devices from the native stream to a second stream; and
transmit simultaneously the first and second streams from the source device.

25. The chip as recited in claim 24, wherein the chip circuitry is configured to be compatible for couplings such that at various times when the source device is coupled with the plurality of display devices,
a first link couples the first one of the plurality of display devices to the chip,
a second link couples the first one of the plurality of display devices to the second one of the plurality of display devices, and
the first and second streams are transmitted simultaneously over the first link to the first one of the plurality of display devices.

26. The chip as recited in claim 25, wherein the first stream is sent over a first lane of the first link and wherein the second stream is sent over a second different lane of the first link.

27. The chip as recited in claim 25, wherein each of the first and second links includes a unidirectional main link arranged to transport packets downstream and a bi-directional auxiliary channel arranged to transfer information between the two associated coupled devices.

28. The chip as recited in claim 25, wherein the at least two display devices form a multi-display sink, wherein the chip is further configured to determine how many displays are in the multi-display sink.

29. The chip as recited in claim 28, wherein the chip circuitry is further configured to determine where each display of the multi-display sink is located in the daisy-chain.

30. The chip as recited in claim 28, wherein the chip circuitry is further configured to notify the multi-display sink that the chip is sending a plurality of streams simultaneously.

31. The chip as recited in claim 24, wherein each of the transmitted streams has identical video timing and pixel bit depth.

32. A chip of a source device configured to provide multimedia streams to a plurality of display devices at certain times when the plurality of display devices are coupled with the source device, the chip comprising code configured to perform steps comprising the following when executed by the chip:
mapping a first subset of pixels for display on a first one of the plurality of display devices from a native stream at the source device to a first stream;
mapping a second subset of pixels for display on a second one of the plurality of display devices from the native stream to a second stream; and
transmitting simultaneously the first and second streams from the source device.

33. The chip as recited in claim 32, wherein the code is configured to be compatible with a system configuration comprising:
a first link coupling the first one of the plurality of display devices to the source device; and
a second link coupling the first one of the plurality of display devices to the second one of the plurality of display devices; such that the first and second streams are transmitted simultaneously over the first link to the first one of the plurality of display devices.

34. The chip as recited in claim 32, wherein the chip comprises a processor coupled to a memory device, wherein at least part of the code is stored in the memory device.

35. The chip as recited in claim 32, wherein at least part of the code comprises firmware embedded in circuitry of the chip.
